(19) United States
(12) Patent Application Publication
(10) Pub. No.: US 2023/0003422 A1
(43) Pub. Date: Jan. 5, 2023

(54) ARRANGEMENT IN A BOREHOLE

(71) Applicant: DOUBLE M PROPERTIES AB, Kokkola (FI)

(72) Inventor: Mats MANDERBACKA, Kokkola (FI)

(21) Appl. No.: 17/783,565

(22) PCT Filed: Dec. 9, 2019
(86) PCT No.: PCT/FI2019/050878

§ 371 Date: Jun. 8, 2022

(51) Int. Cl. F24T 10/17; F28D 7/12

(52) U.S. Cl. CPC F24T 10/17; F28D 7/12

(57) ABSTRACT

The present invention comprises an arrangement in a borehole. Such an arrangement comprises two tubes, an outer tube and an inner tube being arranged within each other having essentially parallel longitudinal axes. Said outer and inner tubes are connected to incoming and outgoing tubes respectively. The cross sectional area of the inner tube is less than half of the cross sectional area of the outer tube, whereby the outer tube and/or the incoming and outgoing tubes arranged in the borehole are insulated until they reach below a freezing depth of the surrounding media. Said the inner tube is also arranged to end before reaching the bottom end of the outer tube when inserted in the borehole, thus forming a fluid passage between the both tubes at the bottom end of said borehole.

### FIELD OF THE INVENTION

The present invention relates to arrangement in a borehole, and more particularly to an arrangement for increasing the efficiency and preventing thermal energy borehole from freezing.

### BACKGROUND OF THE INVENTION

Collecting heat from boreholes by using a heat pump is a widely used and increasingly popular solution for heating buildings. An emerging technology is also Borehole Thermal Energy Storage (BTES), where heat is stored in a surrounding media, such as soil or rock, for later use. In such an arrangement, a heat transferring liquid is pumped through a tube, generally made of a polymer, which tube absorbs or dissipates heat from or to the liquid through the walls of the tube. The rate of heat conductivity is dependent on the thermal conductivity of the tube, the media surrounding the tube, the temperature difference and temperature gradient between the fluid and the surrounding media as well as the thickness of the walls of the tube. Thermal conductivity is defined by “the quantity of energy—in the form of heat—transmitted through a unit thickness of a material per unit time and per unit surface area—in a direction normal to a surface on the unit area—due to a temperature gradient under steady state conditions”. The thermal conductivity is measured in watts per metre per Kelvin: λ=W/(m*K), where W is energy in Watt, m is the material thickness and K is the temperature in Kelvin.

The tube material mostly used is polyethene due to a comparably high thermal conductivity of 0.33 to 0.51 W/(m·K). As a comparison, soil has a thermal conductivity of 0.58 to 1.94 W/(m·K) for sand and 1.23 to 1.59 W/(m·K) for clay. Generally, the thermal conductivity of soil is in most cases more than six times higher than that of the tube. Thus, the thermal conductivity of the tube itself is a significant limiting factor in the heat transfer from the transferring liquid to the surrounding media. This is a significant limitation, especially in BTES systems, where it is desirable to transfer large amounts of energy from the circulated transferring liquid to the thermal storage as well as back from the thermal storage to the transferring liquid.

Furthermore, most existing BTES systems are currently realized in the higher latitudes, which is natural since the need for heating is the highest here. In these higher latitude regions, the temperature typically falls below zero degrees centigrade for extended periods of time, which means that the ground will freeze. This is also the time when most of the heating energy will be extracted from the BTES. In traditional borehole arrangements used to extract heat from the media surrounding the borehole and comprising polymer tubing, the transferring liquid returning to the borehole is typically 4 to 8 degrees colder than the transferring liquid having circulated in the surrounding media. Hereby the transferring liquid returning to the borehole can be sub-zero degrees. Such a cold returning transferring liquid in combination with a cold outside temperature can cause the media surrounding the borehole and/or water in the borehole to freeze, further reducing to the total energy conductivity. The freezing starts from the upper end of the borehole. A freezing at the upper end of the borehole will simultaneously cool the warmed up transferring liquid running from the borehole to the heat pump even before reaching the heat pump. Furthermore, the freezing at the upper end of the borehole can cause an expansion of the media surrounding the BTES tubing hereby compressing the tubing and reducing the flow rate thereof. The increased resistance in the tubing will both limit the heat transfer capacity and increase the power consumption of the pump driving the transferring liquid.

When constructing a BTES system polymer tubes having a diameter of 40 to 50 mm and a wall thickness of 2.4 to 4 mm are inserted in a U-shape in the boreholes. Water or any other suitable heat carrying transferring liquid is circulated in the tubes, whereby the heat transfer rate throughout the length of the borehole tube depends on the temperature difference between the inner and outer sides of the walls of the tube, the transfer rate being exponentially related to this temperature difference.

Furthermore, the polymer tubes generally used have a poor thermal conductivity, which is a limiting factor in both extracting and transferring heat to the surrounding media. Therefore, deeper wells have to be drilled to extract more heat. When using the boreholes for storing energy this is a disadvantage as most of the energy will be lost due to the low temperature gradient and large mass to be material to be heated along the entire length of the borehole.

When charging the BTES hot transferring liquid is pumped down into the borehole the liquid hereby dissipating heat to the surrounding media on the way. Thus, most of the heat is dissipated at the upper end of the borehole where the seasonal losses are the biggest. When using a traditional heat pump without recharging the media surrounding the borehole, the media will start to freeze from the upper end of the borehole. The thermal distribution in the surrounding media is thus such that the media is coldest at the upper end and then have a rather uniform distribution at the entire length of the borehole.

### BRIEF DESCRIPTION OF THE INVENTION

An object of the present invention is to alleviate the above disadvantages and to provide an arrangement so as to. In the case of a BTES it is desirable to dissipate the heat in the lower end of the borehole where the seasonal losses are the smallest. As the temperature of the surrounding media increases with increasing depth, it is also desirable to extract the heat form the lower regions of the borehole in traditional heat pump arrangements.

The objects of the invention are achieved by an arrangement characterized by what is stated in the independent claim 1. The preferred embodiments of the invention are disclosed in the dependent claims.

The foregoing is achieved by an arrangement that dissipates and absorbs the heat at the bottom end of a borehole and significantly increases the heat transfer from between the transferring liquid and the surrounding media. This is especially beneficial in a BTES arrangement but also have benefits for a conventional borehole.

In the present invention, “surrounding media,” means rock, soil or water surrounding a borehole.

Additionally, in the following description, the terms “top”, “bottom”, “upwards”, “downwards” etc. relate to directions in relation to the design details as they are shown in the attached figures.

An advantage of the arrangement of the present invention is that it increases the heat transfer rate between the fluid and the surrounding media. The arrangements also enables the heat to be dissipated and harvested at lower end of the borehole where the heat losses are the lowest.

The present arrangement prevents the upper end of the borehole and a surrounding thereof from freezing and hereby increases the efficiency of a heat pump collecting heat from the boreholes.

When used in a BTES the present invention enables a far greater portion of the heat to be extracted as the heat is dissipated mostly at the lower, and warmer, end of the borehole and not to the entire length of the tube.

The increased thermal conductivity achieved with the present invention means that boreholes may be drilled shallower, which saves a considerable amount of costs.

Further advantages and details of the inventions are more closely set out in the description below.

### BRIEF DESCRIPTION OF THE DRAWINGS

In the following the invention will be described in greater detail by means of preferred embodiments with reference to the accompanying drawings, in which

FIG. 1 illustrates a prior art solution for charging a BTES,

FIG. 2 is a cross section of a solution according to FIG. 1,

FIG. 3 illustrates the present solution for charging a BTES, and

FIG. 4 is a cross section of a solution according to FIG. 3.

### PREFERRED EMBODIMENT

The above-mentioned figures do not show the present arrangement in a borehole to scale, their sole purpose being to illustrate the preferred embodiments' design solutions and the functions of these embodiments. In this connection, the individual design elements that are each shown and labeled with a reference number in the attached figures correspond to the design solutions presented, with corresponding reference numbers, in the description given below.

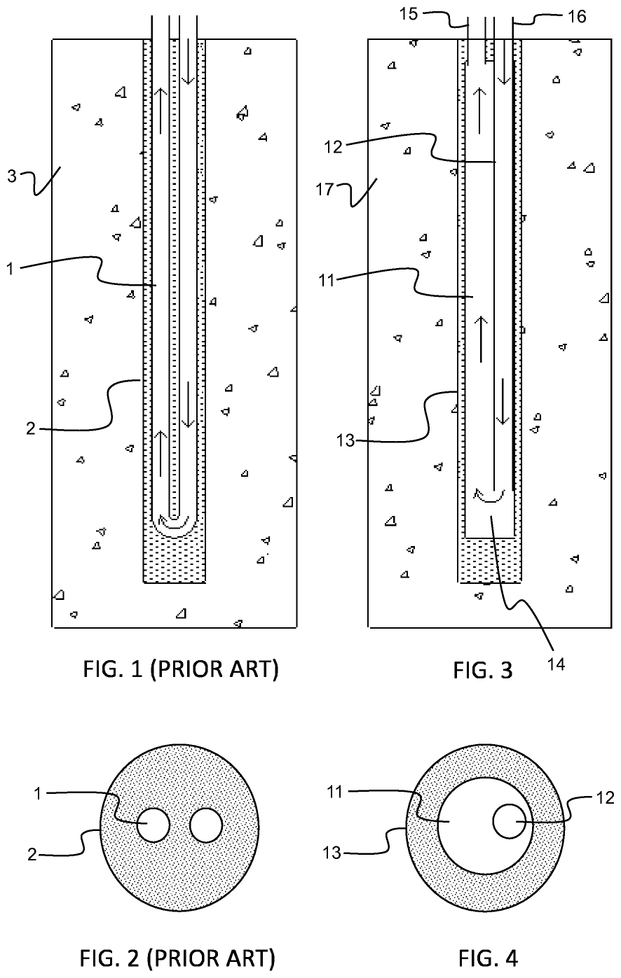

FIGS. 1 and 2 shows a prior art solution for constructing a system for a Borehole Thermal Energy Storage, i.e. a BTES system. As explained above such a system comprises tubes 1 typically having a diameter of 40 to 50 mm and a wall thickness of 2.4 to 4 mm, preferably fabricated of a polymer material. Such a tube is inserted in a U-shape in each of the boreholes 2 forming a BTES. Water or any other suitable heat carrying transferring liquid is then circulated in the tubes, transferring heat either to or from the media 3 surrounding the borehole.

To avoid a too early dissipation of the heat carried by the transferring liquid to the surrounding media or to avoid freezing of the media surrounding the borehole at the upper end thereof, by a sub-zero transferring liquid, a new kind of tubing has been developed.

Thus, the present solution for constructing a BTES system is shown in FIGS. 3 and 4. Such a system comprises two tubes arranged within each other, hereby having essentially parallel longitudinal axes, an outer tube 11 and an inner tube 12. The inner tube 12 and outer tube 11 might be arranged concentric within each other, but they may also be arranged eccentric within each other, as indicated in FIGS. 3 and 4. The inner tube is arranged to end before reaching the bottom end of the outer tube when inserted in a borehole 13, thus forming a fluid passage 14 between the both tubes at the bottom end of said borehole. Hereby the fluid passage from the inner tube to the outer tube at the bottom end of the borehole preferably equals to the diameter of the outer tube. The outer tube preferably has as big a diameter as possible that can fit inside the borehole, whereby the cross to sectional area of the inner tube is half or less than of the cross sectional area of the outer tube. Preferably, the inner tube has a significantly smaller cross sectional area than the outer tube.

The outer tube 11 and the inner tube 12 are connected to regular incoming and outgoing polymer tubes 15 respectively 16 as to connect the tubes to at least one heat source and at least one heat pump respectively. The incoming flow of transferring liquid is hereby directed to the inner tube 12 with the smaller diameter. When transferring heat to the borehole the incoming hot liquid will be transported rapidly to the bottom of the borehole. Due to this rapid transportation, only a small amount heat will be dissipated to the surroundings. As the outer tube 11 has a much larger diameter, the liquid reaching the bottom of the borehole will then slow down and move upwards at a much slower pace due to the larger volume of the outer tube. This slow moving liquid will also allow heat to dissipate through the walls of the outer tube more effectively, whereby most of the heat will be dissipated at the lower end of the borehole.

Furthermore, in many cases the borehole 13 is filled with water outside the outer tube. This water will consequently be heated by the dissipating heat from the transferring liquid, whereby the heated water will also rise upwards along the borehole. The rising water will cause a turbulent flow within the borehole, which will increase the transfer of heat from the water in the borehole to the surrounding media 17. Because of the decreased flow speed of the transferring liquid and the turbulent water within the borehole, most of the heat carried by the transferring liquid will be dissipated in the lower regions of the borehole.

To further enhance the heat dissipation at least the outer tube 11 is manufactured in a material having a high thermal conductivity. Such materials are aluminium, copper or stainless steel, for instance. The conductivity of aluminium usually is more than a 1000 times better than polymers used in tubes, for instance. By using materials having a high thermal conductivity, most of the heat carried by the transferring liquid can be transferred to the surrounding media 17 that is rock, soil or water, at the lower end of the borehole. By choosing a material having a lower thermal conductivity when manufacturing the inner tube 12, the dissipation of heat can be minimized during the flow of the transferring liquid in said inner tube. Thus, at least the outer tube 11 has a high thermal conductivity. Such a conductivity could be achieved by using a stainless steel pipe (conductivity around 15 W/K·m) or an aluminium pipe (conductivity more than 200 W/K·m), for instance.

Depending on the desired amount of energy (heat) that needs to be transferred between the transferring liquid and the character of the media 17 surrounding the borehole 13 the length of the construction can be varied. Likewise the connection of the outer tube 11 and the inner tube 12 to insulated incoming and outgoing tubes 15 respectively 16 may be altered depending on circumstances. If the surrounding media is exposed to freezing, for instance, the connection might be situated below a freezing depth of the surrounding media. Alternatively, the connection might be realized at ground level, whereby the outer tube is insulted until it reaches below a freezing depth of the surrounding media. Thus, the tubes arranged in the boreholes always are insulated until they reach below a freezing depth of the surrounding media.

It will be obvious to a person skilled in the art that, as the technology advances, the inventive concept can be implemented in various ways. The invention and its embodiments are not limited to the examples described above but may vary within the scope of the claims.

1. An arrangement in a borehole, wherein
the arrangement comprises two tubes, an outer tube and an inner tube,
the outer and inner tubes being arranged within each other and being connected to incoming and outgoing tubes, hereby having essentially parallel longitudinal axes, whereby
the cross sectional area of the inner tube is less than half of the cross sectional area of the outer tube, and
the outer tube and/or the incoming and outgoing tubes arranged in the borehole are always insulated until they reach below a freezing depth of the surrounding media, whereby
the inner tube is arranged to end before reaching the bottom end of the outer tube when inserted in the borehole, thus forming a fluid passage between the both tubes at the bottom end of said borehole.

2. An arrangement according to claim 1, wherein at least the outer tube has a thermal conductivity of at least 15 W/K·m.

3. An arrangement according to claim 1, wherein the outer tube has as big a diameter as possible still fitting inside the borehole.

4. An arrangement according to claim 1, wherein the inner tube and outer tube are arranged concentric within each other.

5. An arrangement according to claim 1, wherein the inner tube and outer tube are arranged eccentric within each other.

6. An arrangement according to claim 1, wherein the outer tube and the inner tube are connected to incoming and outgoing tubes as to connect the tubes to at least one heat source and at least one heat pump respectively.

7. An arrangement according to claim 6, wherein an incoming flow of transferring liquid is directed to the inner tube with the smaller diameter.
